(19) United States
(12) Patent Application Publication
(10) Pub. No.: US 2010/0203855 A1
(43) Pub. Date: Aug. 12, 2010

(54) RECEPTION APPARATUS AND RECEPTION METHOD

(75) Inventor: Akinori Komiyama, Tokyo (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/568,062

(22) Filed: Sep. 28, 2009

(30) Foreign Application Priority Data
Sep. 29, 2008 (JP) 2008-251670

(51) Int. Cl. H04B 1/18

(52) U.S. Cl. 455/150.1

(57) ABSTRACT

A reception apparatus includes: a local oscillation section; first and second frequency mixing sections that mix received radio waves from AM and FM broadcast stations with an output signal from the local oscillation section to produce first and second intermediate frequency signals, respectively; an amplitude limiting section that limits an amplitude of the first or second intermediate frequency signal to a predetermined amplitude, and detects an intensity of the radio wave and a frequency offset from the signal; a multipath detecting section that extracts an amplitude change component in the signal amplitude-limited by the amplitude limiting section; and a control section that supplies a control signal for fixing the frequency to the local oscillation section when the intensity of the radio wave from the AM broadcast station and the frequency offset fulfill predetermined criteria, and when the amplitude change component is equal to or lower than a predetermined level.

### BACKGROUND OF THE INVENTION

1. Field of the Invention

The present invention relates to a reception apparatus and reception method, and, more particularly, to a reception apparatus capable of receiving an AM radio broadcast wave and an FM radio broadcast wave, and a reception method using the reception apparatus.

2. Description of the Related Art

In the past, many reception apparatuses which receive an AM radio broadcast wave and FM radio broadcast wave are provided with an automatic search function to automatically receive radio waves of a receivable broadcast station. Such a reception apparatus is provided with a plus key and minus key to instruct initiation of automatic search, so that at the timing when a user presses one of the keys, automatic search is initiated. Upon depression the plus key, for example, frequencies above the then tuned frequency are searched, and when a receivable broadcast station is detected, the broadcast wave thereof is received.

Recently, digital radio broadcasting called HD (High Definition) radio has started, raising a problem such that an erroneous search occurs during automatic search for an analog broadcast station. A digital radio broadcast is transmitted in a transmission system, such as IBOC (In Band On Channel), in which a digital signal is affixed to an existing analog signal band and/or both side bands thereof. This causes a problem of picking up the digital signals affixed to the side bands even during automatic search for an analog FM broadcast wave, stopping the search erroneously.

As an art of solving the problem, for example, JP-A-2008-17292 (Patent Document 1) describes a technique of preventing automatic search for an FM broadcast station from being stopped erroneously due to the influence of the frequency of a digital broadcast station during the automatic search for the FM broadcast station. Specifically, Patent Document 1 describes the technique which provides a reception apparatus with a noise filter including a high pass filter and an amplifier circuit, and continues searching when the amount of detection by the noise filter is equal to or higher than a predetermined level.

### SUMMARY OF THE INVENTION

While Patent Document 1 describes only a scheme of solving the problem that occurs during automatic search for an analog FM broadcast station, an erroneous search also occurs during automatic search for an AM broadcast station. The operation of searching for an AM broadcast station is achieved by checking the following parameters for each frequency to be searched.

(1) The electric field intensity of the received radio wave is equal to or higher than a preset level.

(2) The frequency offset is equal to or lower than a preset level.

When there is the frequency of a digital radio broadcast station around the frequency to be searched, therefore, it may be determined that the electric field intensity is high even though an analog broadcast station does not exist at that frequency, stopping the search. In an AM digital radio broadcast, a digital spectrum of 15 kHz exists on both the upper and lower sides of the frequency band of an analog signal. This is likely to cause an erroneous search particularly in the neighborhood of the frequency band.

Even without a digital broadcast spectrum, when the frequency of an analog AM broadcast with a high electric field intensity exists around the frequency to be searched, automatic search may erroneously be stopped.

Accordingly, it is desirable to prevent erroneous search in carrying out the automatic search for an analog AM broadcast station.

A reception apparatus according to an embodiment of the present invention includes a local oscillation section that changes a frequency of an output signal according to an input control signal, and a first frequency mixing section that mixes a received radio wave from an AM broadcast station with the output signal from the local oscillation section to produce a first intermediate frequency signal. The reception apparatus also includes a second frequency mixing section that mixes a received radio wave from an FM broadcast station with the output signal from the local oscillation section to produce a second intermediate frequency signal. The reception apparatus further includes an amplitude limiting section that limits an amplitude of the first intermediate frequency signal or the second intermediate frequency signal to a predetermined amplitude, and detects an intensity of the radio wave, and a frequency offset from the intermediate frequency signal, and a multipath detecting section that extracts an amplitude change component included in the signal amplitude-limited by the amplitude limiting section. The reception apparatus further includes a control section that supplies a control signal for fixing the frequency to the local oscillation section when the intensity of the radio wave from the AM broadcast station and the frequency offset which are detected by the amplitude limiting section fulfill predetermined criteria, and when the amplitude change component extracted by the multipath detecting section is equal to or lower than a predetermined level.

With this configuration, even in case where the intensity of the radio wave from an AM broadcast station and the frequency offset fulfill predetermined criteria, when an amplitude change component greater than a predetermined level is detected by the multipath detecting section, the oscillation frequency of the local oscillation section is not fixed.

Searching for an AM broadcast wave can be controlled by using the multipath detecting section that is provided to cope with occurrence of a multipath for radio waves from an FM broadcast station.

According to the embodiment of the invention, when an amplitude change component greater than a predetermined level is detected by the multipath detecting section, the oscillation frequency of the local oscillation section is not fixed, making it possible to prevent erroneous search at the time of carrying out the automatic search.

In this case, a circuitry or the like for preventing erroneous search need not be additionally provided, so that the manufacturing cost can be reduced.

### BRIEF DESCRIPTION OF THE DRAWINGS

FIG. 1 is a block diagram showing an example of the internal configuration of a reception apparatus according to one embodiment of the invention;

FIG. 2 is an explanatory diagram showing an example of the structure of an FM stereo signal according to the embodiment of the invention;

FIG. 3 is a flowchart illustrating an example of a process for automatically searching for an AM broadcast station according to the embodiment of the invention;

FIG. 4 is an explanatory diagram showing an example of a search process according to the embodiment of the invention when the frequency of a broadcast station with a high electric field intensity exists around the frequency to be searched;

FIGS. 5A and 5B are explanatory diagrams showing an examples of a search process according to the embodiment of the invention when the frequency of a digital radio broadcast station exists around the frequency to be searched; and

FIG. 6 is a block diagram showing an example of the internal configuration of a reception apparatus according to the related art.

### DETAILED DESCRIPTION OF THE PREFERRED EMBODIMENT

An embodiment of the present invention will be described below with reference to the accompanying drawings. The description of the embodiment is given in the following order.

1. Fundamental Configuration of Receiving Apparatus

2. Example of Receiving Operation of Receiving Apparatus

3. Example of Receiving Process Executed by Receiving Apparatus

3-1. Example in case where a broadcast station with a high electric field intensity exists around the frequency to be searched

3-2. Example in case where a digital radio broadcast station exists around the frequency to be searched

### [Fundamental Configuration of Receiving Apparatus]

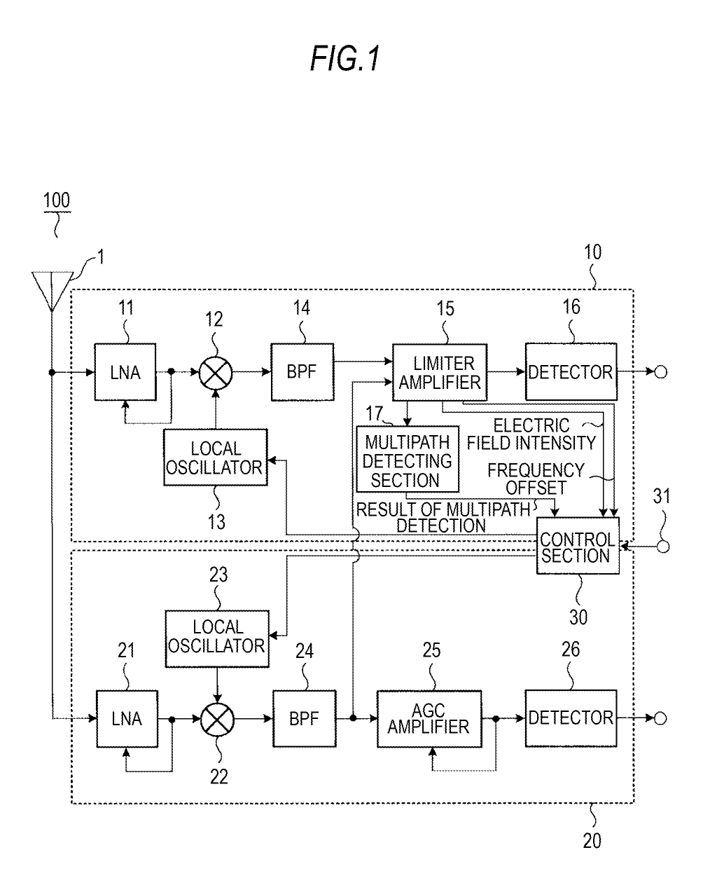

First, referring to FIG. 1, an example of the internal configuration of a reception apparatus 100 according to the embodiment will be described. The reception apparatus 100 capable of receiving an analog AM broadcast and an analog FM broadcast includes an antenna 1, which receives radio waves transmitted from both AM and FM broadcasts, an FM receiving section 10 which receives an FM broadcast, and an AM receiving section 20 which receives an AM broadcast. The reception apparatus 100 further includes a control section 30 which controls both the FM receiving section 10 and AM receiving section 20, and an operation input section 31 having an UP key, a DOWN key, and so forth.

The reception apparatus 100 according to the embodiment is to be mounted in a mobile body, such as an automobile, and has a multipath detecting section as a countermeasure against a multipath-oriented interference. The feature of the reception apparatus 100 lies in that the detection results from the multipath detecting section are referred to in automatic search for an AM broadcast station as well as at the time of receiving an FM broadcast.

The FM receiving section 10 of the reception apparatus 100 has a low noise amplifier (hereinafter called “LNA”) 11, a mixer (first frequency mixing section) 12, a local oscillator 13, a band pass filter (hereinafter called “BPF”) 14, a limiter amplifier (amplitude limiting section) 15, a detector 16, and a multipath detecting section 17.

The LNA 11 amplifies an FM radio wave received at the antenna 1 to a predetermined level, and supplies the amplified radio wave to the mixer 12. In the LNA 11, a feedback loop which controls the gain according to the level of the output from the LNA 11 is formed. The mixer 12 is also supplied with an oscillation frequency supplied from the local oscillator 13. The local oscillator 13 is formed by a PLL (Phase-Locked Loop) synthesizer or the like, and generates a frequency signal for converting the received radio wave to an IF (Intermediate Frequency) signal (first intermediate frequency signal) based on a frequency control voltage output from a PLL circuit (not shown). The oscillation frequency of the frequency signal generated by the local oscillator 13 is changed under the control of the control section 30.

The mixer 12 mixes the received radio wave amplified by the LNA 11 with the oscillation frequency supplied from the local oscillator 13 to generate an IF signal, and supplies the generated IF signal to the BPF 14. The BPF 14 passes only a signal with a desired frequency in the IF signal supplied from the mixer 12, and outputs the signal to the limiter amplifier 15.

The limiter amplifier 15 performs a process of eliminating an amplitude change (AM component) in the IF signal that has passed through the BPF 14 to thereby limit the amplitude of the signal. The limiter amplifier 15 supplies the amplitude-limited signal to the detector 16 and the multipath detecting section 17, and supplies information on the electric field intensity of the received radio wave and the frequency offset that are detected from the IF signal. According to the embodiment, the signal having passed through the BPF 14 is supplied to the limiter amplifier 15 during the operation of the FM receiving section 10, whereas the signal having passed through a BPF 24 of the AM receiving section 20 is supplied to the limiter amplifier 15 during the operation of the AM receiving section 20.

The detector 16 demodulates the signal supplied from the limiter amplifier 15 to acquire an FM broadcast signal. A stereo decoder (not shown) is provided at the subsequent stage of the detector 16 to acquire a left signal and/or a right signal to be output from a speaker (not shown) as a sound.

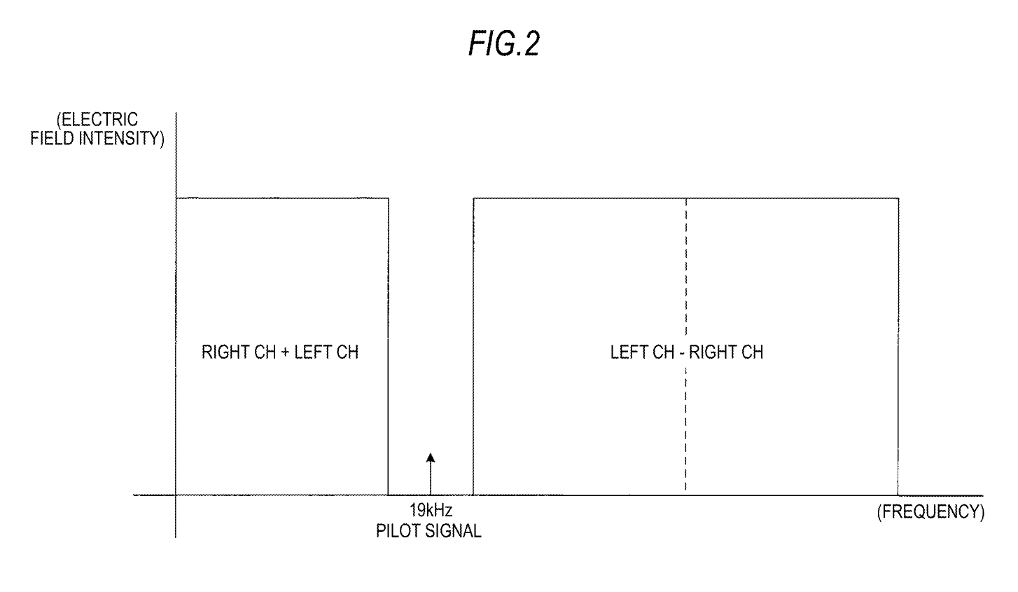

The multipath detecting section 17 extracts an AM component included in the signal supplied from the limiter amplifier 15 to detect occurrence of a multipath, and outputs the extracted AM component to the control section 30. Specifically, an AM component with a frequency around the frequency of a pilot signal of 19 kHz is extracted. As shown in FIG. 2, the pilot signal is a signal superimposed between a sum signal of the left signal and right signal, and a difference signal representing the difference between the left signal and right signal, and has a frequency of 19 kHz.

The frequency of an audio signal, such as a sum signal or a difference signal, is influenced by the level of a sound to provide a difference in the depth of the modulation, and is therefore unfavorable as an AM component to be detected. When the modulation is deep, the frequency may be erroneously detected as a multipath. In addition, a frequency outside the frequency band of an audio signal is very likely to be influenced by the interference of adjoining frequencies, and is likewise unfavorable as an AM component to be detected to detect a multipath.

The pilot signal is characterized by having a constant level and a low degree of modulation or 7.5 kHz deviation. That is, a multipath can be detected more accurately by extracting an AM component in the frequency around the frequency of the pilot signal.

According to the embodiment, like the limiter amplifier 15, the multipath detecting section 17 is configured to operate during the operation of the AM receiving section 20 as well as during the operation of the FM receiving section 10.

When a user instructs the search direction of automatic search through the operation input section 31 having a plus key, a minus key, etc., the control section 30 generates a control signal to search for a frequency above or below the currently tuned frequency based on the content of the operation of the operation input section 31. The control section 30 then supplies the generated control signal to the local oscillator 13.

When the multipath detecting section 17 extracts an AM component, the control section 30 performs various processes of eliminating multipath-oriented noise or deviation according to the level of the AM component. Specifically, the control section 30 performs a process of causing the stereo decoder to extract only a sum signal formed by a left signal and a right signal, a process of eliminating a high-frequency component of a signal, a process of setting mute on, and so forth.

Further, the control section 30 according to the embodiment executes control according to the result of detection performed by the multipath detecting section 17 at the time the AM receiving section 20 is searching for an AM broadcast wave. That is, the control section 30 performs a process of stopping the search when the following conditions are fulfilled during automatic search for an AM broadcast.

(1) The electric field intensity of the radio wave with a frequency to be searched is equal to or higher than a predetermined level preset.

(2) The frequency offset is equal to or lower than a predetermined level preset.

(3) The AM component extracted by the multipath detecting section 17 is equal to or lower than a predetermined level preset.

that is, the control section 30 controls the operation of automatic search. The details of the processes of the control section 30 upon reception of an AM broadcast will be given later.

Next, an example of the configuration of the AM receiving section 20 will be described. the AM receiving section 20 includes an LNA 21, a mixer (second frequency mixing section) 22, a local oscillator 23, the BPF 24, an AGC (Automatic Gain Control) amplifier 25, and a detector 26.

The LNA 21 amplifies an AM radio wave received at the antenna 1 to a predetermined level, and supplies the amplified radio wave to the mixer 22. In the LNA 21, a feedback loop which controls the gain according to the level of the output from the LNA 21 is formed. The mixer 22 is also supplied with an oscillation frequency supplied from the local oscillator 23. The local oscillator 23 generates a frequency signal for converting the received radio wave to an IF signal (second intermediate frequency signal) based on a frequency control voltage output from a PLL circuit (not shown). The oscillation frequency of the frequency signal generated by the local oscillator 23 is set under the control of the control section 30.

The mixer 22 mixes the received radio wave amplified by the LNA 21 with the oscillation frequency supplied from the local oscillator 23 to generate an IF signal, and supplies the generated IF signal to the BPF 24. The BPF 24 passes only a signal with a desired frequency in the IF signal supplied from the mixer 22, and outputs the signal to the AGC amplifier 25 and the limiter amplifier 15 of the FM receiving section 10.

To keep the output substantially constant even when the level of the received radio wave changes, the AGC amplifier 25 controls the gain of the signal having passed through the BPF 24, and supplies the gain-controlled signal to the detector 26. The AGC amplifier 25 is supplied with the output signal of the AGC amplifier 25, so that the feedback loop controls the gain of the AGC amplifier 25.

The detector 26 demodulates the signal supplied from the AGC amplifier 25 to extract an AM broadcast signal.

### [Example of Receiving Operation of Receiving Apparatus]

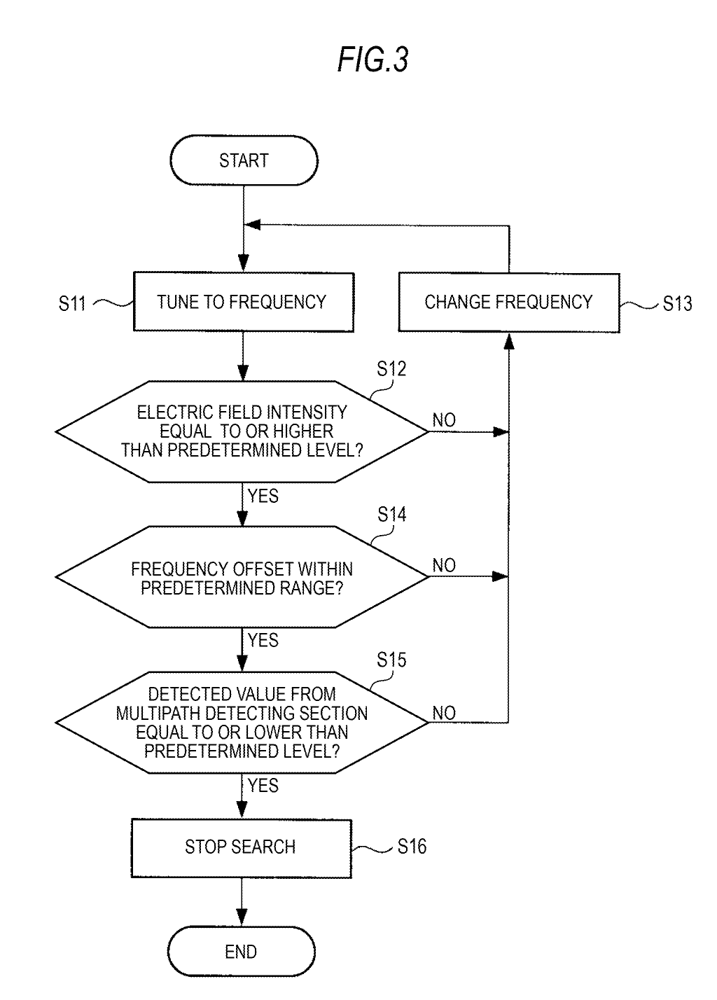

Next, an example of the process the reception apparatus 100 performs to automatically search for an AM broadcast station will be described referring to a flowchart in FIG. 3. First, the local oscillator 23 of the AM receiving section 20 is controlled to tune the oscillation frequency of the local oscillator 23 to a frequency to be searched (step S11). Next, the control section 30 determines whether or not the electric field intensity of the received radio wave which is acquired at the antenna 1 and detected by the limiter amplifier 15 of the FM receiving section 10 is equal to or higher than a predetermined level preset (step S12).

When the electric field intensity of the received radio wave is less than the predetermined level, the control section 30 sends an instruction to shift the frequency upward or downward by a predetermined amount to the local oscillator 23 of the AM receiving section 20 to thereby change the frequency to be received by the reception apparatus 100 (step S13). Since searching for an AM broadcast is normally executed by steps of 10 kHz, a frequency higher by 10 kHz or lower by 10 kHz than the currently tuned frequency is selected. The upward or downward frequency searching direction is changed over according to an instruction from the user input through the UP key, the DOWN key, or the like.

When the electric field intensity of the received radio wave is equal to or higher than the predetermined level, then, the control section 30 determines whether or not the offset frequency detected by the limiter amplifier 15 lies within a prescribed range which has been determined beforehand (step S14). When the offset frequency detected by the limiter amplifier 15 is off the prescribed range which has been determined beforehand, the process of step S13 is executed. That is, the automatic search is continued without interruption.

When the offset frequency detected by the limiter amplifier 15 lies within the prescribed range which has been determined beforehand, it is determined whether or not the AM component (detected value) detected by the multipath detecting section 17 of the FM receiving section 10 is equal to or lower than a predetermined level preset (step S15). When the detected value from the multipath detecting section 17 is higher than the predetermined level, the process of step S13 is executed.

When the detected value from the multipath detecting section 17 is equal to or lower than the predetermined level, the control section 30 performs control to fix the oscillation frequency of the local oscillator 23, and stops the automatic search operation in the reception apparatus 100 (step S16).

### [Example of Receiving Process Executed by Receiving Apparatus]

3-1. Example in Case Where a Broadcast Station with a High Electric Field Intensity Exists Around the Frequency to be Searched

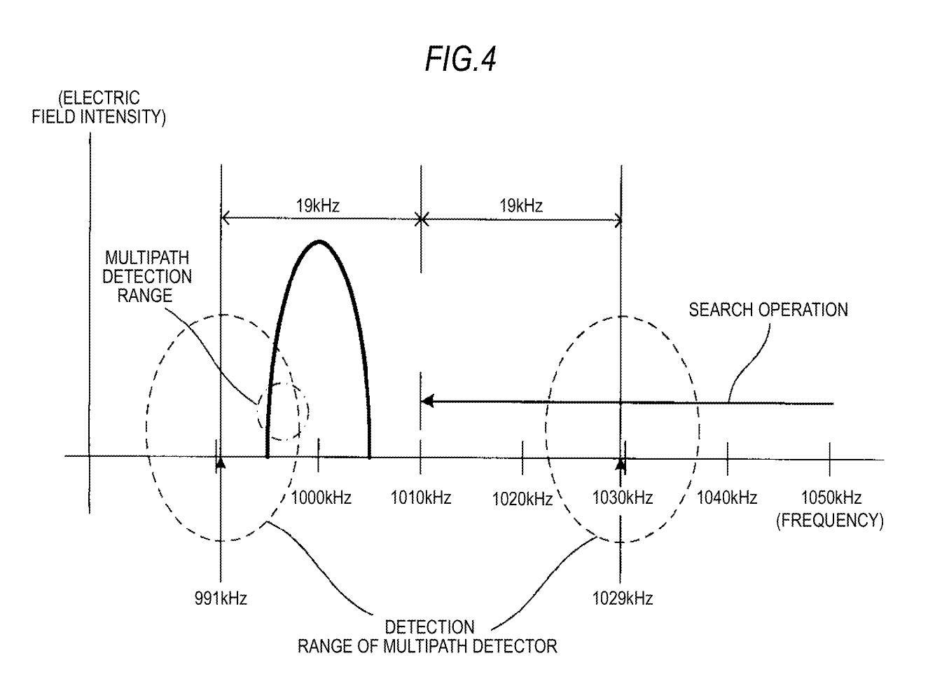

Next, by referring to FIG. 4, a description will be given of an example of the receiving process in a case where a broadcast station with a high electric field intensity exists around the frequency to be searched. In FIG. 4, the ordinate represents the electric field intensity of the received radio wave, and the abscissa represents the frequency (unit of kHz). FIG. 4 shows the automatic search executed in a higher-to-lower direction of frequency and having reached 1010 kHz.

In the example shown in FIG. 4, the frequency of an AM broadcast station is assumed to be 1000 kHz, so that the search should not normally be stopped at 1010 kHz. According to the reception method according to the related art, however, it is decided whether or not to stop searching based only on information on the electric field intensity of the radio wave and the frequency offset, so that the search is very likely to be stopped here. According to the reception method according to the embodiment, by way of contrast, when the frequency is tuned to 1010 kHz, the multipath detecting section 17 extracts an AM component in the vicinity of each frequency apart from 1010 kHz in the upper or lower direction to determine whether or not a multipath has occurred.

In other words, in the example shown in FIG. 4, the multipath detecting section 17 has detection ranges near the frequency of 1010+19=1029 kHz and the frequency of 1010−19=991 kHz. In this case, an AM component (shown by a broken line) originating from the reception of a radio wave from a broadcast station of 1000 kHz is detected in the detection range near 991 kHz. That is, the determination in step S14 in the flowchart shown in FIG. 3 is not fulfilled, so that the automatic search is continued for the next frequency of 1000 kHz tuned, without interruption.

### 3-2. Example in Case Where a Digital Radio Broadcast Station Exists Around the Frequency to be Searched

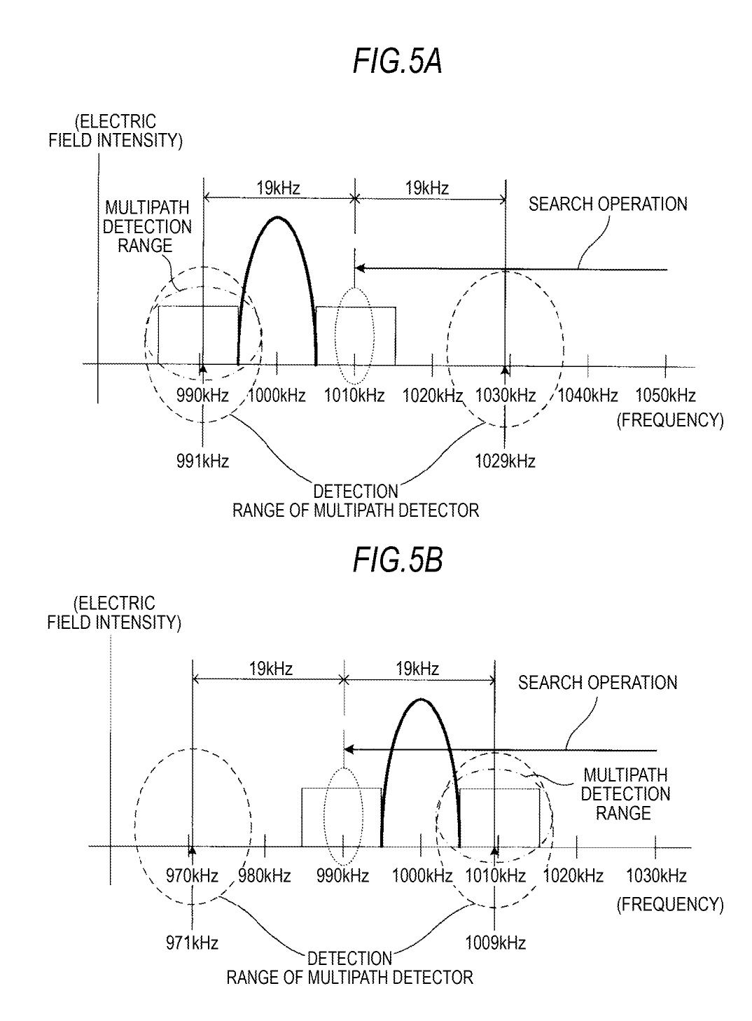

Next, by referring to FIGS. 5A and 5B, a description will be given of examples of the automatic search process in a case where a digital radio broadcast station exists around the frequency to be searched. In FIGS. 5A and 5B, as in FIG. 4, the ordinate represents the electric field intensity of the received radio wave, and the abscissa represents the frequency (unit of kHz). As in the example shown in FIG. 4, the automatic search is executed in a higher-to-lower direction of frequency.

The examples shown in FIGS. 5A and 5B show the co-existing of digital radio frequencies with spectra of digital radio signals indicated by rectangular shapes being present on both sides of the frequency of 1000 kHz of an analog AM broadcast. In the example shown in FIG. 5A, the search has reached the position of 1010 kHz where a digital radio spectrum exists. According to the reception method according to the related art, therefore, it is very likely that the electric field intensity is determined to be high, so that the search will be stopped.

According to the reception method according to the embodiment, by way of contrast, the multipath detecting section 17 detects the occurrence of a multipath near the frequency of 1010+19=1029 kHz and the frequency of 1010−19=991 kHz. In the example shown in FIG. 5A, an AM component (shown by a broken line) originating from the presence of the spectrum of a digital signal is detected in the detection range near 991 kHz. That is, the determination in step S14 in the flowchart shown in FIG. 3 is not fulfilled, so that the automatic search is continued for the next frequency of 1000 kHz tuned, without interruption.

FIG. 5B shows the state where the search has further progressed from the state shown in FIG. 5A and has reached the position of 990 kHz. In this example, the multipath detecting section 17 has detection ranges near the frequency of 990+19=1009 kHz and the frequency of 990−19=971 kHz. In this case, an AM component (shown by a broken line) originating from the presence of the spectrum of a digital signal is detected in the detection range near the frequency of 971 kHz. Accordingly, the determination in step S14 in the flowchart shown in FIG. 3 is not fulfilled, so that the automatic search is continued for the next frequency of 980 kHz tuned, without interruption.

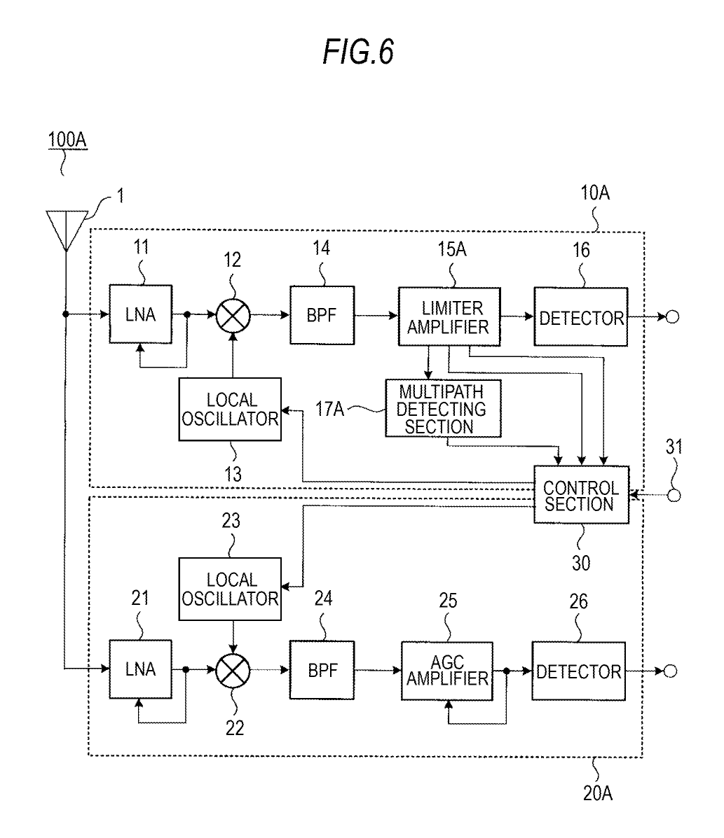

The foregoing embodiment can employ the configuration of the reception apparatus according to the related art without separately providing an erroneous search preventing circuit or the like to thereby prevent erroneous search at the time of executing automatic search for an AM broadcast station. FIG. 6 shows an example of the configuration of the reception apparatus according to the related art. In FIG. 6, same reference numerals are given to those components which are the same as the corresponding components shown in FIG. 1 to omit the detailed descriptions thereof.

A reception apparatus 100A according to the related art shown in FIG. 6 has a multipath detecting section 17A, an FM receiving section 10A which receives a radio wave from an FM broadcast station, and an AM receiving section 20A which receives a radio wave from an AM broadcast station. In the reception apparatus 100A according to the related art, the multipath detecting section 17A is configured to operate only when the FM receiving section 10A receives an FM broadcast. When the multipath detecting section 17A detects a multipath, a process of causing the stereo decoder to extract only a sum signal formed by a left signal and a right signal, a process of eliminating a high-frequency signal component, and a process of setting mute on are executed. When a user instructs the AM receiving section 20A to execute automatic search for an AM broadcast station, the automatic search is executed under the control of a control section 30.

According to the reception apparatus 100 according to the embodiment, by way of contrast, the output of the BPF 24 of the AM receiving section 20 is input to the limiter amplifier 15 of the FM receiving section 10, and the limiter amplifier 15 and the multipath detecting section 17 are allowed to operate during the operation of the AM receiving section 20. Even when the electric field intensity of the received radio wave is high and the frequency offset lies within a predetermined range, automatic search is permitted to continue when the detected value from the multipath detecting section 17 is high.

The foregoing configuration can prevent erroneous search at a place where the automatic search should not normally be stopped, such as in the case of the presence of a broadcast station with a high electric field intensity near the frequency to be searched, or in the case of the presence of the spectrum of a digital broadcast station.

Because an erroneous-search-preventing circuit or the like is not newly provided, the manufacturing cost of the reception apparatus 100 can be reduced.

Even when the number of digital broadcast stations is increased, the reception method according to the embodiment does not stop automatic search erroneously at a frequency where an analog broadcast station does not exist.

The foregoing description of the embodiment has been given of the example where the reception apparatus 100 is to be mounted on an automobile or the like, which is not restrictive. The invention may be adapted to any type of a reception apparatus which has a multipath detecting function.

Although the foregoing description of the embodiment has been given of the example where the local oscillators 13, 23 are respectively provided in the FM receiving section 10 and the AM receiving section 20, the invention may take a configuration where a single local oscillator is shared by both the FM receiving section 10 and the AM receiving section 20.

The present application contains subject matter related to that disclosed in Japanese Priority Patent Application JP 2008-251670 filed in the Japan Patent Office on Sep. 29, 2008, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

1. A reception apparatus comprising:
a local oscillation section that changes a frequency of an output signal according to an input control signal;
a first frequency mixing section that mixes a first received radio wave from an AM broadcast station with the output signal from the local oscillation section to produce a first intermediate frequency signal;
a second frequency mixing section that mixes a second received radio wave from an FM broadcast station with the output signal from the local oscillation section to produce a second intermediate frequency signal;
an amplitude limiting section that limits an amplitude of the first intermediate frequency signal or the second intermediate frequency signal to a predetermined amplitude, and detects an intensity of the first and the second radio waves, and a frequency offset from the first and the second intermediate frequency signals;
a multipath detecting section that extracts an amplitude change component included in the signal amplitude-limited by the amplitude limiting section; and
a control section that supplies a control signal for fixing the frequency to the local oscillation section when the intensity of the first radio wave from the AM broadcast station and the frequency offset which are detected by the amplitude limiting section fulfill predetermined criteria, and when the amplitude change component extracted by the multipath detecting section is equal to or lower than a predetermined level.

2. The reception apparatus according to claim 1, wherein even when the intensity of the first radio wave from the AM broadcast station and the frequency offset which are detected by the amplitude limiting section fulfill the predetermined criteria, the control section supplies a control signal for changing the frequency to the local oscillation section when the amplitude change component extracted by the multipath detecting section is higher than the predetermined level.

3. The reception apparatus according to claim 2, wherein when the amplitude change component of the first intermediate frequency signal detected by the multipath detecting section is equal to or higher than the predetermined level, the control section performs a process of reducing multipath-oriented interference.

4. The reception apparatus according to claim 3, further comprising an operation input section that, upon reception of an instruction from a user, transmits a content of the instruction to the control section, wherein a direction of a frequency change in the local oscillation section is determined based on the instruction from the user.

5. A reception method comprising:
producing a first intermediate frequency signal by mixing a first received radio wave from an AM broadcast station with the output signal from a local oscillation section;
producing a second intermediate frequency signal by mixing a second received radio wave from an FM broadcast station with the output signal from the local oscillation section;
limiting an amplitude of the first intermediate frequency signal or the second intermediate frequency signal to a predetermined amplitude, and detecting an intensity of the first and the second radio waves, and a frequency offset from the first and the second intermediate frequency signals;
extracting an amplitude change component included in the amplitude-limited signal;
supplying a control signal for fixing the frequency to the local oscillation section when the detected intensity of the radio wave from the AM broadcast station and the frequency offset fulfill predetermined criteria, and when the extracted amplitude change component is equal to or lower than a predetermined level; and
causing the local oscillation section to change a frequency of the output signal thereof according to the control signal.
